(19) United States
(12) Patent Application Publication
(10) Pub. No.: US 2007/0092179 A1
(43) Pub. Date: Apr. 26, 2007

(54) MEMS module package

(75) Inventors: Heung-Woo Park, Seoul (KR); Yeong-Gyu Lee, Suwon-si (KR); Chang-Su Park, Suwon-si (KR); Ohk-Kun Lim, Suwon-si (KR); Dong-Hyun Park, Seoul (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon-si (KR)

(21) Appl. No.: 11/546,696

(22) Filed: Oct. 11, 2006

(30) Foreign Application Priority Data
Aug. 7, 2006 (KR) 10-2006-0074258
Oct. 11, 2005 (KR) 10-2005-0095316

(51) Int. Cl. G02B 6/12

(52) U.S. Cl. 385/14

(57) ABSTRACT

The present invention relates to a MEMS package, and in particular, to the structure of a MEMS package. One aspect of the invention provides an optical modulator module package comprising a substrate, an optical modulator positioned on the substrate which modulates an optical signal and transmits the optical signal through the substrate, a driver IC (driver integrated circuit) mounted adjacent to the optical modulator which operates the optical modulator, circuit wiring formed on the substrate and configured which transfers signals for operating the optical modulator, and a printed circuit board positioned facing the substrate on the optical modulator and the driver IC for signal connection with an external circuit. With a MEMS module package according to an aspect of the invention, the overall size can be reduced by providing a different form of layer composition.

### BACKGROUND

1. Technical Field

The present invention relates to a MEMS package, and in particular, to the structure of a MEMS package.

2. Description of the Related Art

An optical modulator is a circuit or device which loads signals on a beam of light (optical modulation) when the transmission medium is optical fiber or free space in the optical frequency range. The optical modulator is used in such fields as optical memory, optical display, printers, optical interconnection, and holograms, etc., and a great deal of development research is currently under way on display devices using the optical modulator.

The optical modulator may involve MEMS (microelectromechanical systems) technology, in which three-dimensional structures are formed on silicon substrates using semiconductor manufacturing technology. There are a variety of applications in which MEMS is used, examples of which include various sensors for vehicles, inkjet printer heads, HDD magnetic heads, and portable telecommunication devices, in which the trend is towards smaller devices capable of more functionalities.

The MEMS element has a movable part spaced from the substrate to perform mechanical movement. MEMS can also be called a micro electromechanical system or element, and one of its applications is in the optical science field. Using micromachining technology, optical components smaller than 1 mm may be fabricated, by which micro optical systems may be implemented. Specially fabricated semiconductor lasers may be attached to supports prefabricated by micromachining technology, so that micro Fresnel lenses, beam splitters, and 45° reflective mirrors may be manufactured and assembled by micromachining technology. Existing optical systems are composed using assembly tools to place mirrors and lenses, etc. on large, heavy optical benches. The size of the lasers is also large. To obtain performance in optical systems such composed, significant effort is required in the several stages of careful adjustment to calibrate the light axes, reflective angles, and reflective surfaces, etc.

Micro optical systems are currently selected and applied in telecommunication devices and information display and recording devices, due to such advantages as quick response time, low level of loss, and convenience in layering and digitalizing. For example, micro optical components such as micro mirrors, micro lenses, and optical fiber supports may be applied to data storage recording devices, large image display devices, optical communication elements, and adaptive optics.

Here, micromirrors are applied in various ways according to the direction, such as the vertical, rotational, and sliding direction, and to the static and dynamic movement. Movement in the vertical direction is used in such applications as phase compensators and diffractometers, with movement in the direction of inclination used in applications such as scanners or switches, optical splitters, optical attenuators, and movement in the sliding direction used in optical shields or switches, and optical splitters.

The size and number of micromirrors vary considerably according to the application, and the application varies according to the direction of movement and to whether the movement is static or dynamic. Of course, the method of manufacturing micromirrors also varies accordingly.

FIG. 1 is an exploded perspective view of a conventional optical modulator module package. Referring to FIG. 1, the optical modulator module package 100 comprises a printed circuit board 110, a transparent substrate 120, an optical modulator 130, driver IC's (driver integrated circuits) 140a to 140d, a heat release plate 150, and a connector 160.

The printed circuit board 110 is a commonly used printed circuit board intended for semiconductor packages, and the lower face of the transparent substrate 120 is attached onto the printed circuit board 110. Also, the optical modulator 130 is attached to the upper surface of the transparent substrate 120 in correspondence with a hole formed on the printed circuit board 110.

The optical modulator 130 modulates the incident light entering through the hole of the printed circuit board 110 and emits diffraction light. The optical modulator 130 is flip chip connected to the transparent substrate 120. Adhesive is placed around the optical modulator 130 to form a seal from the outside environment, and electrical connection is maintained by the electrical wiring formed along the surface of the transparent substrate 120.

The driver IC's 140a to 140d are flip chip connected around the optical modulator 130 onto which the transparent substrate 120 is attached and supply driving power to the optical modulator 130 according to the control signals inputted from the outside.

The heat release plate 150 removes heat generated from the optical modulator 130 and the driver IC's 140a to 140d, and thus a metallic material is typically used which easily releases heat.

A manufacturing method of the optical modulator module package 100 illustrated in FIG. 1 includes: attaching an electrical connector 160 to a printed circuit board 110; attaching an optical modulator 130 and driver IC's 140a to 140d to a transparent substrate 120; dispensing adhesive around the optical modulator 130 to form a seal; stacking the transparent substrate 120 on the printed circuit board 110 and performing wire bonding; and attaching a heat release plate 150 to the optical modulator 130 and the driver IC's 140a to 140d.

It is to be noted that the optical modulator module package 100 illustrated in FIG. 1 has a relatively large number of components. Also, since the numerous components require an adequate amount of space, there is a limit to minimizing the size of the module package. For instance, since the transparent substrate 120 is positioned on the printed circuit board 110, the board 110 needs to be bigger than the transparent substrate 120, and therefore the overall size of the optical modulator module package 100 is increased.

### SUMMARY

The present invention aims to provide a MEMS module package, with which the overall size of the package can be reduced by providing a different form of layer composition.

Another object of the invention is to provide a MEMS module package, in which the electrical/optical functions are not concentrated on the light transmissive lid, as the optical modulator is not mounted directly on the light transmissive lid.

Yet another object of the invention is to provide a MEMS module package, with which the overall size of the package can be reduced by utilizing various cap shapes and various sealing methods.

Other technical virtues of the invention will easily be understood through the descriptions provided below.

One aspect of the invention may provide an optical modulator module package comprising a lower substrate, an optical modulator positioned on the lower substrate which modulates an optical signal and transmits the optical signal through the lower substrate, a driver IC (driver integrated circuit) mounted adjacent to the optical modulator which operates the optical modulator, circuit wiring formed on the lower substrate and configured which transfers signals for operating the optical modulator, and a printed circuit board positioned facing the lower substrate on the optical modulator and the driver IC for signal connection with an external circuit.

Here, a portion of the lower substrate corresponding with the optical modulator may be transparent to allow the transmission of light.

Further, a portion of the lower substrate corresponding with the optical modulator may be formed from glass having anti-reflective optical coating to allow the transmission of light.

Also, an optical modulator module package according to an embodiment of the invention may further comprise a sealing cap positioned between the printed circuit board and the optical modulator which seals the optical modulator.

One or more grooves may be formed in the sealing cap for housing the optical modulator and the driver IC, and the sealing cap may form a seal with the lower substrate.

The sealing cap may house the optical modulator only or may house the driver IC as well.

The lower substrate may be one of a semiconductor substrate, LTCC (low temperature cofired ceramic), HTCC (high temperature cofired ceramic), and a multilayer printed circuit board.

Also, in an optical modulator module package according to an embodiment of the invention, a hole may be formed in the lower substrate in a portion corresponding with the optical modulator, and the lower substrate may further comprise a light transmissive lid which seals the hole and allows the transmission of light.

The electrical connection between the lower substrate and the printed circuit board may be achieved either by wire boding or TAB (tape automated bonding).

Here, the bonding wires may be protected by epoxy resin when the electrical connection between the lower substrate and the printed circuit board is formed by wire bonding.

The printed circuit board may further comprise and form a single body with a flexible PCB (flexible printed circuit board).

The printed circuit board may also comprise a connector for connecting with an external circuit.

The optical modulator and the driver IC may be mounted on the lower substrate by a single adhesive.

Here, the adhesive may comprise an anisotropic conductive film (ACF) or a non-conductive film (NCF).

The optical modulator may be side-sealed by epoxy resin.

Also, an optical modulator module package according to an embodiment of the invention may further comprise a sealing dam, formed in an area where the optical modulator is connected with the lower substrate, for protecting an operation area of the optical modulator.

Another aspect of the invention may provide a MEMS package comprising a lower substrate, a MEMS (microelectromechanical systems) element positioned on the lower substrate which transmits a signal to the exterior or receives a signal from the exterior, a driver IC (driver integrated circuit) mounted adjacent the MEMS element for operating the MEMS element, and a printed circuit board positioned facing the lower substrate on the MEMS element and the driver IC for signal connection with an external circuit.

A MEMS package according to an embodiment of the invention may further comprise a sealing cap positioned between the printed circuit board and the MEMS element which seals the MEMS element.

Here, one or more grooves may be formed in the sealing cap for housing the MEMS element and the driver IC, and the sealing cap may form a seal with the lower substrate by any one of epoxy, solder, frit glass, and LCP (liquid crystal polymer).

The sealing cap may house the MEMS element only or may house the driver IC as well.

The lower substrate may be any one of a semiconductor substrate, LTCC (low temperature cofired ceramic), HTCC (high temperature cofired ceramic), and a multilayer printed circuit board.

The electrical connection between the lower substrate and the printed circuit board may be achieved either by wire boding or TAB (tape automated bonding).

Here, the bonding wires may be protected by epoxy resin when the electrical connection between the lower substrate and the printed circuit board is formed by wire bonding.

The printed circuit board may further comprise and form a single body with a flexible PCB (flexible printed circuit board).

The printed circuit board may also comprise a connector for connecting with an external circuit.

The MEMS element and the driver IC may be mounted on the lower substrate by a single adhesive.

The MEMS element may be side-sealed by epoxy resin.

Also, a MEMS package according to an embodiment of the invention may further comprise a sealing dam, formed in an area where the MEMS element is connected with the lower substrate, for protecting an operation area of the MEMS element.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is an exploded perspective view of a conventional optical modulator module package.

FIG. 2A is a perspective view of a diffraction type optical modulator module using a piezoelectric element, applicable to an embodiment of the invention.

FIG. 2B is a perspective view of another diffraction type optical modulator module using a piezoelectric element, applicable to an embodiment of the invention.

FIG. 2C is a plan view of a diffraction type optical modulator module array, applicable to an embodiment of the invention.

FIG. 2D is a schematic diagram illustrating an image generated on a screen by means of a diffraction type optical modulator array applicable to an embodiment of the invention.

FIG. 3 is a perspective view of an optical modulator module package according to a first disclosed embodiment of the present invention.

FIG. 4A is a cross-sectional view of an optical modulator module package according to a first disclosed embodiment of the present invention.

FIG. 4B is a cross-sectional view of an optical modulator module package according to a second disclosed embodiment of the present invention.

FIG. 5 is a cross-sectional view of an optical modulator module package according to a third disclosed embodiment of the present invention.

FIG. 6 is a cross-sectional view of an optical modulator module package according to a fourth disclosed embodiment of the present invention.

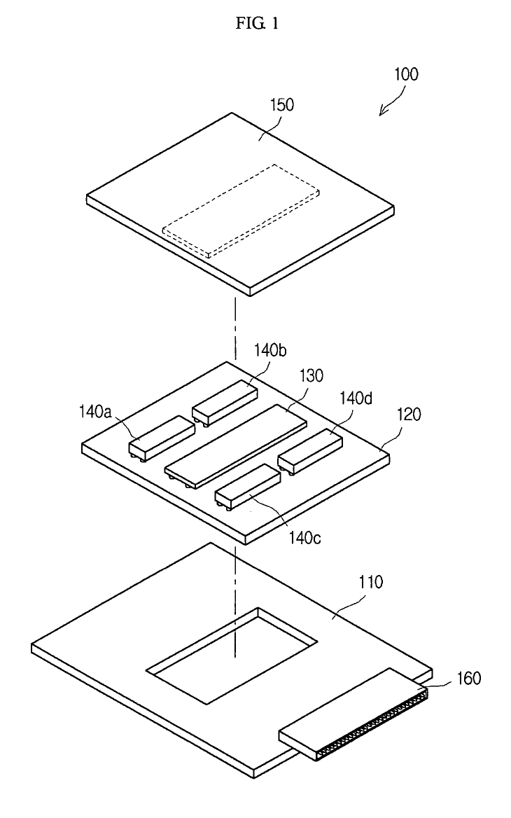

### DETAILED DESCRIPTION

Embodiments of the invention will be described below in more detail with reference to the accompanying drawings. In the description with reference to the accompanying drawings, those components are rendered the same reference number that are the same or are in correspondence regardless of the figure number, and redundant explanations are omitted. Embodiments of the invention may be applied to a MEMS package for generally transmitting signals to the exterior or receiving signals from the exterior, and among the various MEMS packages applicable to the invention, the optical modulator will first be described before discussing the disclosed embodiments of the invention.

An optical modulator can be divided mainly into a direct type, which directly controls the on/off state of light, and an indirect type, which uses reflection and diffraction, where the indirect type may further be divided into an electrostatic type and a piezoelectric type. The optical modulator may be applied to the invention regardless of the operational type.

An electrostatic type grating optical modulator as disclosed in U.S. Pat. No. 5,311,360 has light-reflective surfaces and includes a plurality of equally spaced-apart deformable ribbons suspended over the substrate.

First, an insulation layer is deposited on a silicon substrate, followed by a process of depositing a silicon dioxide film and a silicon nitride film. The silicon nitride film is patterned into ribbons, and portions of the silicon dioxide layer are etched so that the ribbons are maintained by the nitride frame on the oxide spacer layer. To modulate light having a single wavelength λ0, the modulator is designed such that the thicknesses of the ribbons and the oxide spacer to be λ0/4.

The grating amplitude, of such a modulator limited to the vertical distance d between the reflective surfaces of the ribbons and the reflective surface of the substrate, is controlled by supplying voltage between the ribbons (the reflective surfaces of the ribbons, which act as first electrodes) and the substrate (the conductive film at the bottom portion of the substrate, which acts as the second electrode).

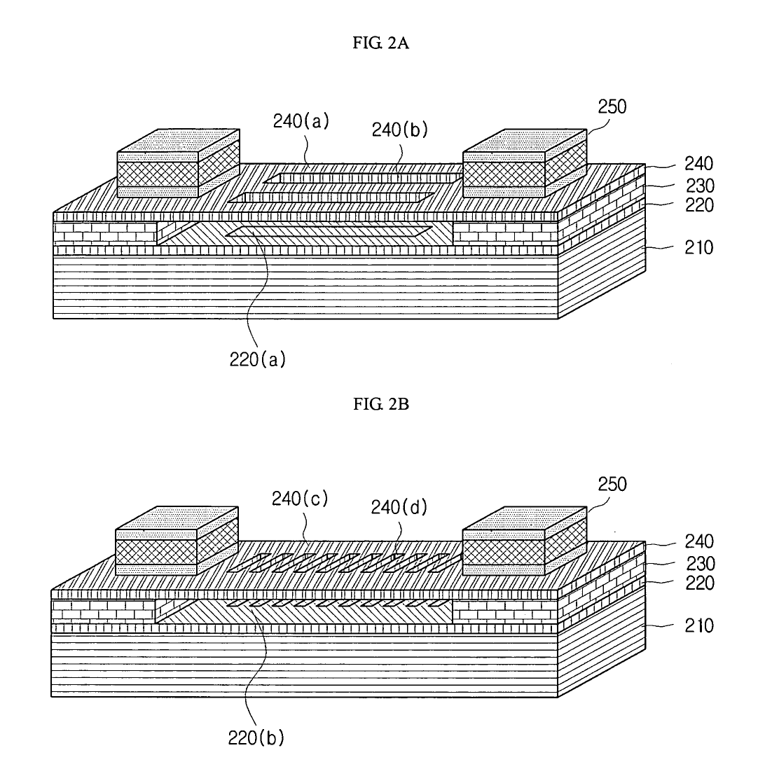

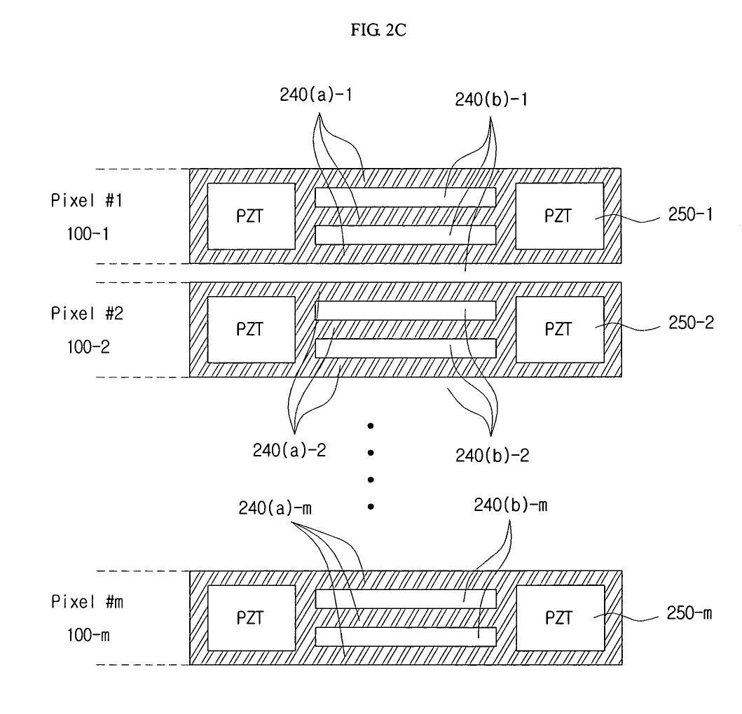

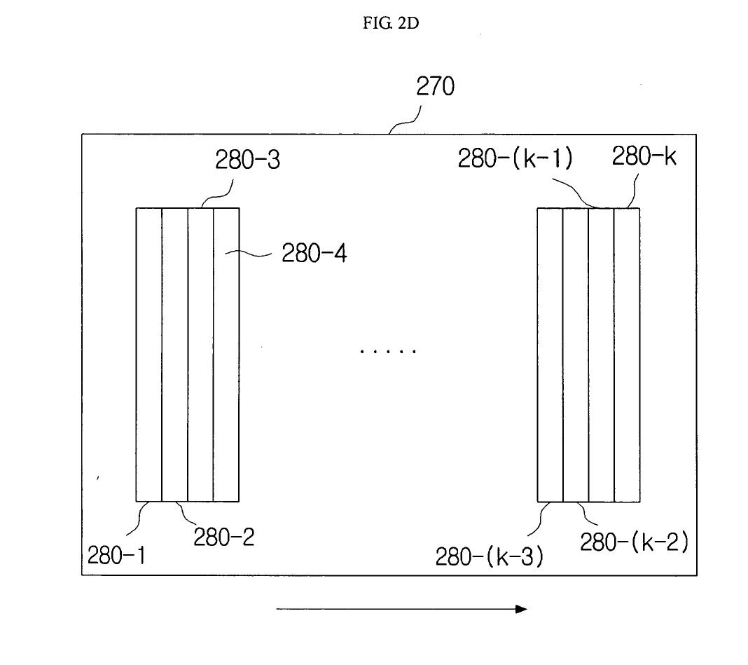

FIG. 2A is a perspective view of a diffraction type optical modulator module using a piezoelectric element applicable to an embodiment of the invention, and FIG. 2B is a perspective view of another diffraction type optical modulator module using a piezoelectric element applicable to an embodiment of the invention. Referring to FIGS. 2A and 2B, an optical modulator is illustrated which comprises a substrate 210, an insulation layer 220, a sacrificial layer 230, a ribbon structure 240, and piezoelectric elements 250.

The substrate 210 is a generally used semiconductor substrate, while the insulation layer 220 is deposited as an etch stop layer and is formed from a material with a high selectivity to the etchant (the etchant is an etchant gas or an etchant solution) that etches the material used for the sacrificial layer. Here, a reflective layer 220a, 220b may be formed on the insulation layer 220 to reflect incident beams of light.

The sacrificial layer 230 supports the ribbon structure 240 from both sides, such that the ribbon structure may be spaced by a constant gap from the insulation layer 220, and forms a space in the center.

The ribbon structure 240 creates diffraction and interference in the incident light to provide optical modulation of signals as described above. The ribbon structure 240 may be composed of a plurality of ribbon shapes according to the electrostatic type, or may comprise a plurality of open holes in the center portion of the ribbons according to the piezoelectric type. The piezoelectric elements 250 control the ribbon structure 240 to move vertically, according to the degree of up/down or left/right contraction or expansion generated by the difference in voltage between the upper and lower electrodes. Here, the reflective layers 220(a), 220(b) are formed in correspondence with the holes 240(b), 240(d) formed in the ribbon structure 240.

For example, in the case where the wavelength of a beam of light is λ, when there is no power supplied or when there is a predetermined amount of power supplied, the gap between an upper reflective layer 240(a), 240(c) formed on the ribbon structure and the insulation layer 220, on which is formed a lower reflective layer 220(a), 220(b), is equal to nλ/2 (wherein n is a natural number). Therefore, in the case of a 0-order diffracted (reflected) beam of light, the overall path length difference between the light reflected by the upper reflective layer 240(a), 240(c) formed on the ribbon structure and the light reflected by the insulation layer 220 is equal to nλ, so that constructive interference occurs and the diffracted light is rendered its maximum luminosity. In the case of +1 or −1 order diffracted light, however, the luminosity of the light is at its minimum value due to destructive interference.

Also, when an appropriate amount of power is supplied to the piezoelectric elements 250, other than the supplied power mentioned above, the gap between the upper reflective layer 240(a), 240(c) formed on the ribbon structure and the insulation layer 220, on which is formed the lower reflective layer 220(a), 220(b), becomes (2n+1)λ/4 (wherein n is a natural number). Therefore, in the case of a 0-order diffracted (reflected) beam of light, the overall path length difference between the light reflected by the upper reflective layer 240(a), 240(c) formed on the ribbon structure and the light reflected by the insulation layer 220 is equal to (2n+1)λ/2, so that destructive interference occurs, and the diffracted light is rendered its minimum luminosity. In the case of +1 or −1 order diffracted light, however, the luminosity of the light is at its maximum value due to constructive interference. As a result of such interference, the optical modulator can load signals on the beams of light by controlling the quantity of the reflected or diffracted light.

While the foregoing describes the cases in which the gap between the ribbon structure 240 and the insulation layer 220, on which is formed the lower reflective layer 220(a), 220(b), is nλ/2 or (2n+1)λ/4, it is obvious that a variety of embodiments may be applied with regards the present invention which are operated with gaps that allow the control of the interference by diffraction and reflection.

The descriptions below will focus on the type of optical modulator illustrated in FIG. 2A described above.

Referring to FIG. 2C, the optical modulator is composed of an m number of micromirrors 100-1, 100-2, . . . , 100-m, each responsible for pixel #1, pixel #2, . . . , pixel #m. The optical modulator deals with image information with respect to 1-dimensional images of vertical or horizontal scanning lines (here, it is assumed that a vertical or horizontal scanning line consists of an m number of pixels), while each micromirror 100-1, 100-2, . . . , 100-m deals with one pixel among the m pixels constituting the vertical or horizontal scanning line. Thus, the light reflected and diffracted by each micromirror is later projected by an optical scanning device as a 2-dimensional image on a screen. For example, in the case of VGA 640*480 resolution, modulation is performed 640 times on one surface of an optical scanning device (not shown) for 480 vertical pixels, to generate 1 frame of display per surface of the optical scanning device. Here, the optical scanning device may be a polygon mirror, a rotating bar, or a galvano mirror, etc.

While the description below of the principle of optical modulation concentrates on pixel #1, the same may obviously apply to other pixels.

In the present embodiment, it is assumed that the number of holes 240(b)-1 formed in the ribbon structure 240 is two. Because of the two holes 240(b)-1, there are three upper reflective layers 240(a)-1 formed on the upper portion of the ribbon structure 240. On the insulation layer 220, two lower reflective layers are formed in correspondence with the two holes 240(b)-1. Also, there is another lower reflective layer formed on the insulation layer 220 in correspondence with the gap between pixel #1 and pixel #2. Thus, there are an equal number of upper reflective layers 240(a)-1 and lower reflective layers per pixel, and as discussed with reference to FIG. 2A, it is possible to control the luminosity of the modulated light using 0-order diffracted light or ±1-order diffracted light.

FIG. 2D is a schematic diagram illustrating an image generated on a screen by means of a diffraction type optical modulator array applicable to an embodiment of the invention.

Illustrated is a display 280-1, 280-2, 280-3, 280-4, . . . , 280-(k-3), 280-(k-2), 280-(k-1), 280-k generated when beams of light reflected and diffracted by an m number of vertically arranged micromirrors 100-1, 100-2, . . . , 100-m are reflected by the optical scanning device and scanned horizontally onto a screen 270. One image frame may be projected with one revolution of the optical scanning device. Here, although the scanning direction is illustrated as being from left to right (the direction of the arrow), it is apparent that images may be scanned in other directions (e.g. in the opposite direction).

Embodiments of the invention relate to a technique of positioning the printed circuit board on an upper portion of the optical modulator to form an optical modulator module package with the overall size reduced. That is, the printed circuit board is positioned on an upper portion of the optical modulator, and the wiring of the printed circuit board through which signals for the operation of the optical modulator are input to the driver IC's are joined to the lower substrate by wire bonding or TAB (tape automated bonding). In the invention, any substrate on which fine-pitch wiring is possible, such as a transparent substrate, a semiconductor substrate, LTCC (low temperature cofired ceramic), and HTCC (high temperature cofired ceramic), may be applied as the lower substrate. Here, a substrate other than the transparent substrate may have a hole to allow the passage of light, and the hole may be sealed by a light transmissive lid.

The foregoing explanation described perspective views and plan views illustrating the optical modulator in general, and the MEMS module package according to aspects of the invention will be described below based on specific embodiments, with reference to the accompanying figures. Four embodiments are disclosed in the description, each of them explained in order.

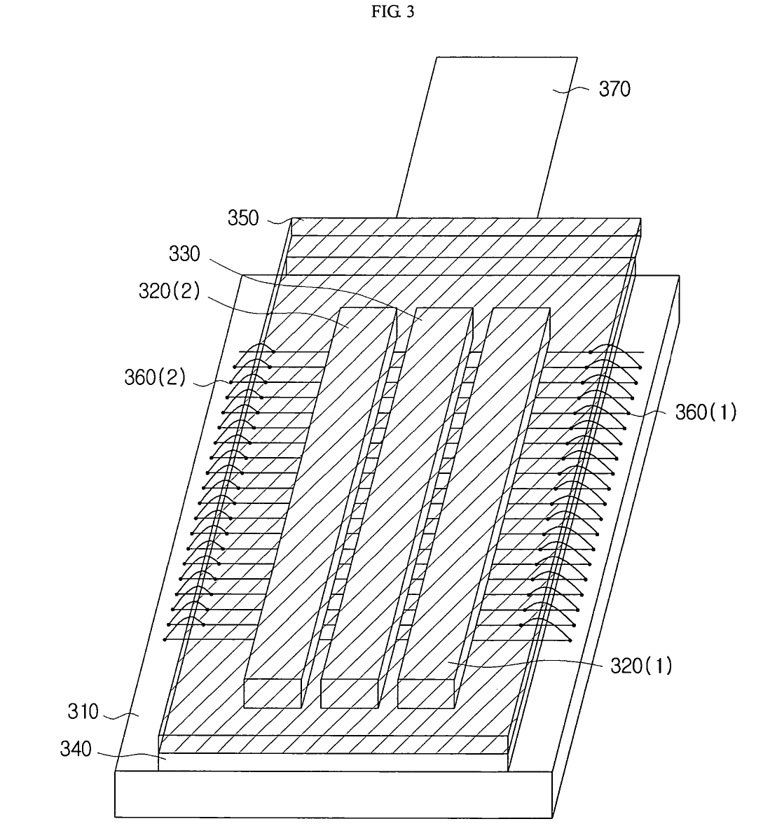

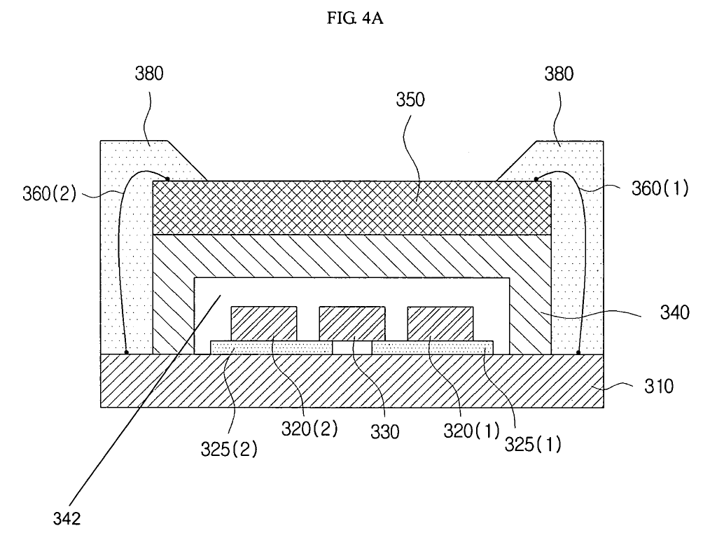

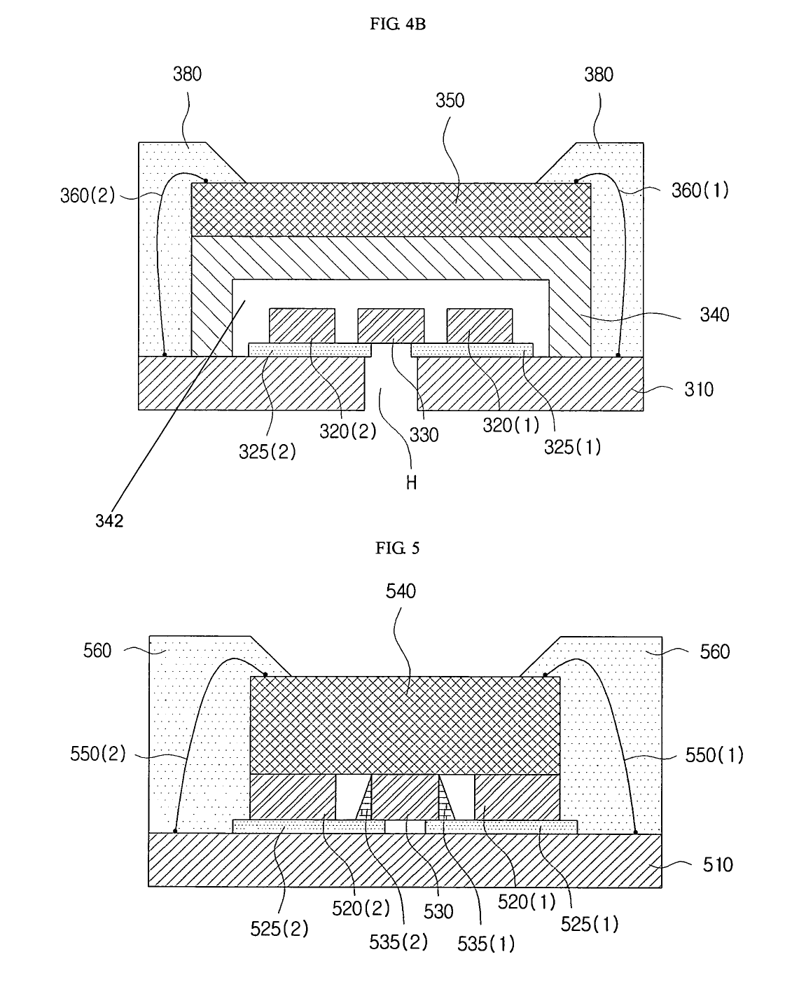

FIG. 3 is a perspective view of an optical modulator module package according to a first disclosed embodiment, in which a cap is used to protect the optical modulator, and FIG. 4A is a cross-sectional view of an optical modulator module package according to a first disclosed embodiment of the present invention, in which a cap is used to protect the optical modulator. In FIGS. 3 and 4A are illustrated a lower substrate 310, driver IC's (driver integrated circuits) 320(1), 320(2), adhesive 325(1), 325(2), an optical modulator 330, a sealing cap 340, a printed circuit board 350, bonding wires 360, a flexible PCB (flexible printed circuit board) (370) and epoxy 380 for protecting the bonding wires. Also, FIG. 4B is a cross-sectional view of an optical modulator module package according to a second disclosed embodiment of the present invention, in which a cap is used to protect the optical modulator when a particular hole is formed in the lower substrate 310. The first and second disclosed embodiments will be described below in more detail.

The lower substrate 310 is formed with a hole H through which incident light may be inputted to the optical modulator 330 or diffracted light may be emitted, or is formed from a transparent material, and a circuit is formed on at least one of the inside or the outer surface of the substrate. The lower substrate 310 may be a regular semiconductor substrate, having a transparent portion or having a hole to allow the transmission of light. Thus, the lower substrate 310 transfers control signals inputted from an external control circuit (not shown) to the driver IC's 320(1), 320(2). Here, the electrical connection with the driver IC's 320(1), 320(2) may be achieved through flip chip bonding. The lower substrate 310 may further include metal bumps attached on one side for mounting the optical modulator and driver IC's on the substrate. The metal bumps may be flip chip connected to a metal pad formed on the optical modulator or the driver integrated circuits. Here, the lower substrate 310 may be one of LTCC (low temperature cofired ceramic) having heat releasing capability, HTCC (high temperature cofired ceramic), a transparent substrate, a semiconductor substrate, a printed circuit board (including a multilayer printed circuit board) or any other suitable structure.

Referring to FIG. 4A, if the lower substrate 310 is a transparent substrate, anti-reflective optical coating may be applied to either side of the transparent substrate to allow the transmission of light. Here, the transparent substrate may be a glass substrate.

Referring to FIG. 4B, since the lower substrate 310 may not be transparent if the lower substrate 310 is one of a semiconductor substrate, LTCC, HTCC, and a printed circuit board, a hole may be formed in the lower substrate 310 in an area corresponding with the optical modulator 330 through which incident light entering the optical modulator 330 or the diffracted light emitted may pass. Here, the hole formed on the lower substrate 310 may be sealed by a light transmissive lid (e.g. glass) (not shown) through which light may be transmitted. The light transmissive lid may seal the hole in various positions, such as at the center or upper/lower regions of the hole.

The driver IC's 320(1), 320(2) are flip chip connected adjacent the optical modulator 330 and supply driving power to the optical modulator 330 according to the control signals inputted from the outside. The number of driver IC's 320(1), 320(2) may be increased or decreased depending on the size and/or other requirements of the optical modulator 330. That is, although there are two driver IC's 320(1), 320(2) illustrated in FIG. 3, the disclosed embodiment is not limited to this case.

The optical modulator 330 modulates the incident light entering through the hole formed on the lower substrate 310 or through the transparent lower substrate 310 and emits diffracted light. Here, the optical modulator 330 may be flip chip connected to the lower substrate 310. Also, the cross section of the optical modulator 330 may be rectangular, being relatively longer in one direction.

Further, the optical modulator 330 and driver IC's 320(1), 320(2) may be mounted on the lower substrate 310 by a single adhesive. In other words, the areas on the lower substrate 310 where the optical modulator 330 and driver IC's 320(1), 320(2) are to be mounted may first be designated, and then a single adhesive may be coated on the lower substrate 310 in a single process, with the optical modulator 330 and driver IC's 320(1), 320(2) mounted on the lower substrate 310 afterwards. Here, any suitable adhesive may be used, regardless of its form, which can electrically and mechanically attach the chips to the substrate. For example, an adhesive may be applied to the invention which comprises any one or any combination of ACF (anisotropic conductive film), NCF (non-conductive film), NCP (non-conductive paste), and ACP (anisotropic conductive paste).

The sealing cap 340 is positioned between the lower substrate 310 and the printed circuit board 350, and has a cavity or groove 342 formed inside to house the optical modulator 330 (the driver IC's 320(1), 320(2) may be included). Here, the sealing cap 340 is sealed to the lower substrate 310 by an adhesive medium. Here, the adhesive medium may be a sealant such as epoxy, solder, frit glass, and/or LCP (liquid crystal polymer), by which the sealing cap 340 may be sealed to the lower substrate 310. Thus, the sealing cap 340 protects the optical modulator 330 and the driver IC's 320(1), 320(2) from outside humidity and pressure, etc. That is, the sealing cap 340 is positioned between the printed circuit board 350 and the optical modulator 330 and performs the function of sealing the optical modulator 330.

The sealing cap 340 may be made from a metallic material. Also, as will be described below, the sealing cap 340 may be omitted, with the printed circuit board 350 positioned directly on the optical modulator 330 and the driver IC's 320(1), 320(2). When the sealing cap 340 according to the invention is not used, the optical modulator 330 and the driver IC's 320(1), 320(2) may be protected from outside humidity and pressure, etc., by means of side-sealing around the optical modulator 330 with epoxy or forming one or more sealing dams inside the optical modulator 330.

The material for the sealing cap 340 may be an alloy of Fe 53%, Ni 29%, Co 17% when it is made from Kovar, which has a low coefficient of thermal expansion, and may be an alloy of Fe 63%, Ni 36% when it is made from Invar. The sealing cap 340 may have a cross section the shape of a hat, and may protect the optical modulator 330 from outside humidity. Here, the sealing cap 340 can prevent the infiltration of humidity more effectively than can the conventional mounting material of epoxy resin, with the effect of preventing the infiltration of humidity especially great when the sealing cap 340 is a metal. Here, the coefficient of thermal expansion of the sealing cap 340 can be similar to that of the glass substrate or the optical modulator 330, to which the bottom surface of the sealing cap is to be attached. As noted above, the material composing the sealing cap 340 may be Kovar or Invar. As the coefficients of thermal expansion of Kovar and Invar are relatively low, they may be equal or similar to the coefficient of thermal expansion of the optical modulator 330. Here, the coefficient of thermal expansion of the sealing cap 340 is 5.86 ppm/° C. for Kovar and 1.3 ppm/° C. for Invar.

The printed circuit board 350 is positioned on or above the optical modulator 330 and the driver IC's 320(1), 320(2), has circuit wiring formed thereon to transfer signals for operating the optical modulator 330 to the driver IC's 320(1), 320(2), and is electrically connected to the circuit wiring formed on the lower substrate 310. Here, the printed circuit board 350 may be bonded to the lower substrate 310 by wire bonding 360 or by TAB (tape automated bonding). When the printed circuit board 350 is wire bonded 360 to the lower substrate 310, passivation may form on the wires 360 bonding the lower substrate 310 and the printed circuit board 350 to each other, due to the epoxy resin 380.

Since the flexible PCB 370 is able to bend, it is flexible in receiving electrical signals from an external circuit (e.g. the mother board). In other words, a flexible PCB 370 may be used to house an optical modulator module package even in a tight space. In this case, a connector (not shown) may be formed at one end of the flexible PCB 370 for joining with an external circuit. Here, the printed circuit board 350 may comprise a rigid board and flexible board 370 as a detachable type or a single body type. That is, when the printed circuit board 350 is a rigid board, it may be formed as a single body with a flexible board (a flexible PCB) 370 electrically joined with an external circuit, or it may be formed as a detachable type allowing the flexible board (a flexible PCB) 370 to be detached and reattached. The epoxy 380 for protecting the bonding wires may be formed to envelop the wires 360 used for wire bonding, thus providing protection from outside humidity and pressure, etc.

FIG. 5 is a cross-sectional view of an optical modulator module package according to a third disclosed embodiment of the present invention, in which the optical modulator is side-sealed. In FIG. 5 are illustrated a lower substrate 510, driver IC's 520(1), 520(2), adhesive 525(1), 525(2), an optical modulator 530, epoxy resin 535(1), 535(2), a printed circuit board 540, bonding wires 550(1), 550(2), and epoxy 560 for protecting the bonding wires. The description will be focused on differences from the first disclosed embodiment set forth above.

The optical modulator 530 may be side-sealed with epoxy resin 535(1), 535(2). In other words, the optical modulator 530 may be protected by coating epoxy resin 535(1), 535(2) around the optical modulator 530. That is, epoxy resin 535(1), 535(2) typically has the superior mechanical properties of cured resin, has high dimensional stability, and has high mechanical workability, which may be used to protect the optical modulator 530. Here, the heights of the optical modulator 530 and the driver IC's 520(1), 520(2) may be equal or substantially equal to each other. Thus, the printed circuit board 540 may be positioned directly on the optical modulator 530 and driver IC's 520(1), 520(2).

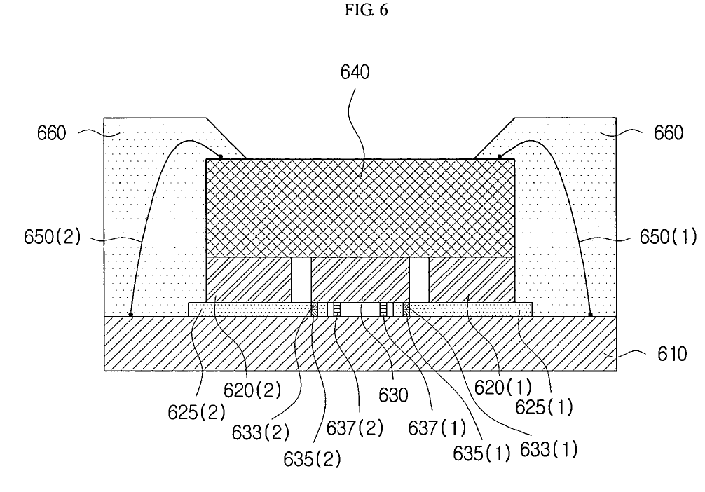

FIG. 6 is a cross-sectional view of an optical modulator module package according to a fourth disclosed embodiment of the present invention, in which dams are formed. In FIG. 6 are illustrated a lower substrate 610, driver IC's 620(1), 620(2), adhesive 625(1), 625(2), an optical modulator 630, optical modulator pads 633(1), 633(2), lower substrate bumps 635(1), 635(2), sealing dams 637(1), 637(2), a printed circuit board 640, bonding wires 650(1), 650(2), and epoxy 660 for protecting the bonding wires. The description will be focused on differences from the first disclosed embodiment set forth above.

The optical modulator 630 may also be sealed by forming sealing dams 637(1), 637(2) around it. That is, sealing dams 637(1), 637(2) may be provided to protect the micro operation area of the optical modulator 630 formed inside the area in which the optical modulator 630 is electrically connected with the lower substrate 610 by means of adhesive, etc. Here, the optical modulator 630 and the lower substrate 610 are electrically joined to each other by means of optical modulator pads 633(1), 633(2) and lower substrate bumps 635(1), 635(2).

The sealing dams 637 may be eutectic solder or a metal such as gold (Au), etc. Here, the eutectic solder may be a fluxless solder such as AuSn, etc., or may be a solder having one of the lowest melting points, such as InSn or Sn, whereby the processes may be performed at low temperatures when it is applied to an embodiment of the invention. When metal is used for the sealing dams 637, the signal wiring of the optical modulator 630 may be protected by insulators, and an adhesion film may be formed on the lower substrate 610 at the region where it is attached to the sealing dams 637(1), 637(2).

The present invention is not limited to the foregoing embodiments, and it is to be appreciated that those skilled in the art can change or modify the embodiments without departing from the spirit of the invention.

As set forth above, with a MEMS module package according to an aspect of the invention, the overall size can be reduced by providing a different form of layer composition.

Also, in a MEMS module package according to an aspect of the invention, the electrical/optical functions are not concentrated on the light transmissive lid, as the optical modulator is not mounted directly on the light transmissive lid.

Further, with a MEMS module package according to an aspect of the invention, the overall size can be reduced by using various cap shapes and various sealing methods.

While the invention has been described with reference to the disclosed embodiments, it is to be appreciated that those skilled in the art can change or modify the embodiments without departing from the scope and spirit of the invention or its equivalents as stated below in the claims.

Also, while the foregoing embodiments have been described in relationship to packages for optical modulators, other types of microelectromechanical system (MEMS) elements may be packaged in accordance with the foregoing embodiments. Such MEMS devices or elements may include, for example, gyroscopic or acceleration sensors, such as used in motor devices and aircraft. Other types of MEMS devices may include inertia sensors or Lorentz (magnetic) sensors. These additional types of MEMS elements may also require that the substrate be transparent or that a hole be formed therein for passing light. With this exception, the embodiments disclosed above could be employed in conjunction with these additional MEMS elements or even other MEMS elements.

What is claimed is:

1. An optical modulator module package comprising:
a substrate;
an optical modulator positioned on the substrate and configured to modulate an optical signal and to transmit the optical signal through the substrate;
a driver IC (driver integrated circuit) mounted adjacent to the optical modulator and configured to operate the optical modulator;
circuit wiring formed on the substrate and configured to transfer a signal for operating the optical modulator; and
a printed circuit board positioned facing the substrate on the optical modulator and the driver IC for signal connection with an external circuit.

2. The optical modulator module package of claim 1, wherein at least a portion of the substrate corresponding with the optical modulator is transparent to allow light transmission.

3. The optical modulator module package of claim 2, wherein at least a portion of the substrate corresponding with the optical modulator is formed from glass having anti-reflective optical coating to allow light transmission.

4. The optical modulator module package of claim 1, further comprising a sealing cap positioned between the printed circuit board and the optical modulator and configured to seal the optical modulator.

5. The optical modulator module package of claim 4, wherein the sealing cap has one or more grooves formed therein for housing the optical modulator and the driver IC and forms a seal with the substrate.

6. The optical modulator module package of claim 4, wherein the sealing cap houses the optical modulator and the driver IC.

7. The optical modulator module package of claim 4, wherein the sealing cap houses the optical modulator.

8. The optical modulator module package of claim 1, wherein the substrate is any one of a semiconductor substrate, LTCC (low temperature cofired ceramic), HTCC (high temperature cofired ceramic), and a multilayer printed circuit board.

9. The optical modulator module package of claim 8, wherein the substrate has a hole formed therein in a portion corresponding with the optical modulator and further comprises a light transmissive lid configured to seal the hole and to allow light transmission.

10. The optical modulator module package of claim 1, wherein electrical connection is formed between the substrate and the printed circuit board by either one of wire boding or TAB (tape automated bonding).

11. The optical modulator module package of claim 10, wherein bonding wires are protected by epoxy resin when the electrical connection between the substrate and the printed circuit board is formed by wire bonding.

12. The optical modulator module package of claim 1, wherein the printed circuit board further comprises and forms a single body with a flexible PCB (flexible printed circuit board).

13. The optical modulator module package of claim 1, wherein the printed circuit board comprises a connector for connecting with an external circuit.

14. The optical modulator module package of claim 1, wherein the optical modulator and the driver IC are mounted on the substrate by a single adhesive.

15. The optical modulator module package of claim 14, wherein the adhesive comprises an anisotropic conductive film (ACF) or a non-conductive film (NCF).

16. The optical modulator module package of claim 1, wherein the optical modulator is side-sealed by epoxy resin.

17. The optical modulator module package of claim 1, further comprising a sealing dam, formed in an area where the optical modulator is connected with the substrate, for protecting an operation area of the optical modulator.

18. A MEMS package comprising:
a substrate;
a MEMS (microelectromechanical systems) element positioned on the substrate and configured to transmit a signal to the exterior of the MEMS package or to receive a signal from the exterior;
a driver IC (driver integrated circuit) mounted adjacent the MEMS element and configured to operate the MEMS element; and
a printed circuit board positioned facing the substrate on the MEMS element and the driver IC for signal connection with an external circuit.

19. The MEMS package of claim 18, wherein further comprising a sealing cap positioned between the printed circuit board and the MEMS element and configured to seal the MEMS element.

20. The MEMS package of claim 19, wherein the sealing cap has one or more grooves formed therein for housing the MEMS element and the driver IC and forms a seal with the substrate by any one of epoxy, solder, frit glass, and LCP (liquid crystal polymer).

21. The MEMS package of claim 19, wherein the sealing cap houses the MEMS element and the driver IC.

22. The MEMS package of claim 19, wherein the sealing cap houses the MEMS element.

23. The MEMS package of claim 18, wherein the substrate is any one of a semiconductor substrate, LTCC (low temperature cofired ceramic), HTCC (high temperature cofired ceramic), and a multilayer printed circuit board.

24. The MEMS package of claim 18, wherein electrical connection is formed between the substrate and the printed circuit board by either one of wire boding or TAB (tape automated bonding).

25. The MEMS package of claim 24, wherein bonding wires are protected by epoxy resin when the electrical connection between the substrate and the printed circuit board is formed by wire bonding.

26. The MEMS package of claim 18, wherein the printed circuit board further comprises and forms a single body with a flexible PCB (flexible printed circuit board).

27. The MEMS package of claim 18, wherein the printed circuit board comprises a connector for connecting with an external circuit.

28. The MEMS package of claim 18, wherein the MEMS element and the driver IC are mounted on the substrate by a single adhesive.

29. The MEMS package of claim 18, wherein the MEMS element is side-sealed by epoxy resin.

30. The MEMS package of claim 18, further comprising a sealing dam, formed in an area where the MEMS element is connected with the substrate, for protecting an operation area of the MEMS element.
